(19) United States
(12) Patent Application Publication
(10) Pub. No.: US 2014/0075102 A1
(43) Pub. Date: Mar. 13, 2014

(54) CONTROLLER OF A NONVOLATILE MEMORY DEVICE AND A COMMAND SCHEDULING METHOD THEREOF

(71) Applicant: Samsung Electronics Co., Ltd., Suwon-Si (KR)

(72) Inventors: SANGYOON OH, Gyeonggi-do (KR); Sangcheol Lee, Gyeonggi-do (KR)

(73) Assignee: Samsung Electronics Co., Ltd., Suwon-si (KR)

(21) Appl. No.: 14/020,046

(22) Filed: Sep. 6, 2013

(30) Foreign Application Priority Data
Sep. 7, 2012 (KR) 10-2012-0099510

(51) Int. Cl. G06F 12/02

(52) U.S. Cl. CPC G06F 12/0246
USPC 711/103

(57) ABSTRACT

A controller which includes a working memory on which a command scheduler is loaded; and a processor configured to load at least one mapping table from a mapping table array onto the working memory. The command scheduler reorders commands provided from a host based on logical block addresses, and the processor loads at least one other mapping table onto the working memory according to logical block addresses of the commands reordered by the command scheduler.

### CROSS-REFERENCE TO RELATED APPLICATION

This U.S. non-provisional patent application claims priority under 35 U.S.C. §119 to Korean Patent Application No. 10-2012-0099510 filed Sep. 7, 2012, in the Korean Intellectual Property Office, the disclosure of which is incorporated by reference herein in its entirety.

### BACKGROUND

1. Technical Field

The inventive concept relates to a controller of a nonvolatile memory device and a command scheduling method thereof.

2. Discussion of the Related Art

Individual data use has continued to increase in our information-oriented society. A variety of personal information storage devices have been developed to meet this demand.

Among the information storage devices, a hard disk drive (HDD) has been widely used due to its characteristics such as high recording density, high data transfer speed, fast data access time, low cost, and so on. The HDD may consist of a circular disk in which data is stored, a head to record data on the disk or to read data from the disk and an arm connected with the head. The disk may consist of at least one or more aluminum plates coated by a magnetic material. The disk may be referred to as a platter.

Recently, a solid state disk (SSD) using a nonvolatile memory as an information storage device has been used in place of the HDD. Unlike the HDD, the SSD has an electric composition instead of a mechanical composition. The SSD may have superior access speed, ability to be downsized, and stability against an impact in comparison with the HDD.

### SUMMARY

An exemplary embodiment of the inventive concept provides a controller which comprises a working memory on which a command scheduler is loaded; and a processor configured to load at least one mapping table from a mapping table array onto the working memory, wherein the command scheduler reorders commands provided from a host based on logical block addresses; and wherein the processor loads at least one other mapping table onto the working memory according to logical block addresses of the commands reordered by the command scheduler.

In an exemplary embodiment of the inventive concept, the command scheduler reorders the commands such that commands having logical block addresses included in the same mapping table are successively executed.

In an exemplary embodiment of the inventive concept, logical block addresses of the commands are determined to be included in the same mapping table based on the logical block addresses of the commands and a size of a logical block address included in at least one of the mapping tables.

In an exemplary embodiment of the inventive concept, the mapping table array is stored at a data storage device which stores data according to a control of the controller.

In an exemplary embodiment of the inventive concept, the controller further comprises a nonvolatile memory at which the mapping table array is stored.

In an exemplary embodiment of the inventive concept, the commands are Native Command Queuing (NCQ) or Tagged Command Queuing (TCQ) commands.

In an exemplary embodiment of the inventive concept, the controller provides an interface to queue commands.

An exemplary embodiment of the inventive concept provides a command scheduling method of a nonvolatile memory device which comprises determining logical block addresses of commands provided from a host; determining zones in which the logical block addresses of the commands are included; and reordering the commands based on the determined zones, wherein each of the zones includes at least one logical block address included in a mapping table.

In an exemplary embodiment of the inventive concept, the zones are determined on the basis of a size of a logical block address included in at least one of the mapping tables and the logical block addresses of the commands.

In an exemplary embodiment of the inventive concept, the command scheduling method further comprises dividing commands having a logical block address included in a plurality of zones into subcommands, wherein reordering the commands comprises reordering the subcommands based on their zones.

In an exemplary embodiment of the inventive concept, reordering the commands comprises identifying the commands having logical block addresses belonging to the same zone; and reordering the commands in the same zone.

In an exemplary embodiment of the inventive concept, the commands in the same zone are reordered such that commands having adjacent logical block addresses are successively executed.

In an exemplary embodiment of the inventive concept, reordering the commands in the same zone comprises determining a logical block address next to a command having a lowest execution priority; and reordering the commands in the same zone, based on the logical block address next to the command having the lowest execution priority, such that commands having adjacent logical block addresses are successively executed.

In an exemplary embodiment of the inventive concept, the commands in the same zone are reordered such that a read command is executed prior to a write command.

In an exemplary embodiment of the inventive concept, the commands in the same zone are reordered according to an order in which they were received.

An exemplary embodiment of the inventive concept provides a command scheduler configured to calculate zone identities (IDs) for a plurality of queued commands and re-queue the commands based on the zone IDs, wherein a zone includes a logical block address and a physical block address.

The commands are re-queued such that commands having the same zone ID are successively executed.

The controller includes an interface to receive the commands.

The controller further comprises a working memory on which the command scheduler is stored.

The controller further comprises a data storage device configured to provide the working memory with a mapping table.

### BRIEF DESCRIPTION OF THE DRAWINGS

The above and other features of the inventive concept will become more apparent by describing in detail exemplary embodiments thereof with reference to the attached drawings.

FIG. 1 is a block diagram illustrating a nonvolatile memory device and a host according to an exemplary embodiment of the inventive concept.

FIG. 2 is a block diagram illustrating a controller in FIG. 1, according to an exemplary embodiment of the inventive concept.

FIG. 3 is a diagram illustrating mapping tables according to an exemplary embodiment of the inventive concept.

FIG. 4 is a diagram illustrating a table switching operation according to an exemplary embodiment of the inventive concept.

FIG. 5 is a timing diagram illustrating a general command execution operation.

FIG. 6 is a timing diagram illustrating a command execution operation according to an exemplary embodiment of the inventive concept.

FIG. 7 is a flow chart illustrating a command scheduling method according to an exemplary embodiment of the inventive concept.

FIG. 8 is a flow chart illustrating a command scheduling method according to an exemplary embodiment of the inventive concept.

FIG. 9 is a flow chart illustrating a command scheduling method according to an exemplary embodiment of the inventive concept.

FIG. 10 is a flow chart illustrating an operation of reordering commands having the same zone ID, according to an exemplary embodiment of the inventive concept.

FIG. 11 is a block diagram illustrating a memory card system including a nonvolatile memory device according to an exemplary embodiment of the inventive concept.

FIG. 12 is a block diagram illustrating a universal flash storage system in which a nonvolatile memory device according to an exemplary embodiment of the inventive concept is applied.

FIG. 13 is a block diagram illustrating an electronic device implemented using a memory device according to an exemplary embodiment of the inventive concept.

### DETAILED DESCRIPTION OF THE EMBODIMENTS

Hereinafter, exemplary embodiments of the inventive concept will be described in detail with reference to the accompanying drawings. The inventive concept, however, may be embodied in various different forms, and should not be construed as being limited to the illustrated embodiments. Like reference numerals may denote like elements throughout the attached drawings and written description.

As used herein, the singular forms “a,” “an” and “the” are intended to include the plural forms as well, unless the context clearly indicates otherwise.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

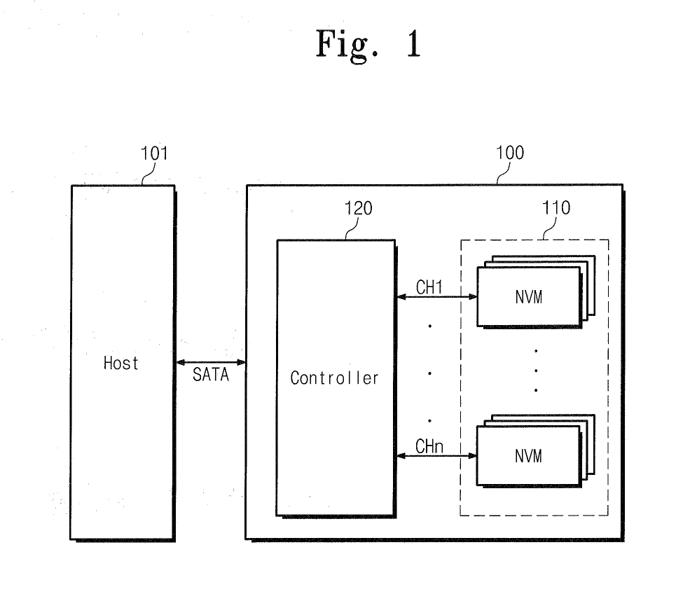

FIG. 1 is a block diagram illustrating a nonvolatile memory device and a host according to an exemplary embodiment of the inventive concept. Referring to FIG. 1, a nonvolatile memory device 100 may include a data storage device 110 and a controller 120.

A host 101 may control the nonvolatile memory device 100. For example, the host 101 may be an electronic device such as a handheld electronic device (e.g., a portable media player (PMP), a personal digital assistant (PDA), a smart phone, etc.), a computer, or a high-definition television (HDTV).

The nonvolatile memory device 100 may operate responsive to a control of the host 101. Data stored at the nonvolatile memory device 100 may be retained at power-off. The nonvolatile memory device 100 may be a solid state drive (SSD), for example. However, the inventive concept is not limited thereto.

The nonvolatile memory device 100 according to an exemplary embodiment of the inventive concept may store commands input from the host 101. The nonvolatile memory device 100 may perform scheduling on the stored commands based on logical block addresses of the commands. With the command scheduling, a table switching time at execution of the commands may be reduced. Thus, it is possible to improve an operating speed of the nonvolatile memory device 100.

The data storage device 110 may store data according to a control of the controller 120. The data storage device 110 and the controller 120 may be connected via a plurality of channels CH1 to CHn. Each of the plurality of channels CHI to CHn may be connected with a plurality of nonvolatile memories NVM.

In exemplary embodiments of the inventive concept, the data storage device 110 may include flash memories. However, the inventive concept is not limited thereto. For example, the data storage device 110 may also include nonvolatile memories such as magnetoresistive random access memory (MRAM), phase-change RAM (PRAM), and so on. In the case that the data storage device 110 is formed of flash memories, it may be formed of various types of flash memory cells and may have various data storage characteristics.

The controller 120 may respond to a command input from the host 101 to control an operation in which data is stored at the data storage device 110. In addition, the controller 120 may respond to a command input from the host 101 to control an operation in which data is read out from the data storage device 110.

The controller 120 may store commands input from the host 101 before execution of the commands. The controller 120 may control an execution priority of the stored commands based on logical block addresses.

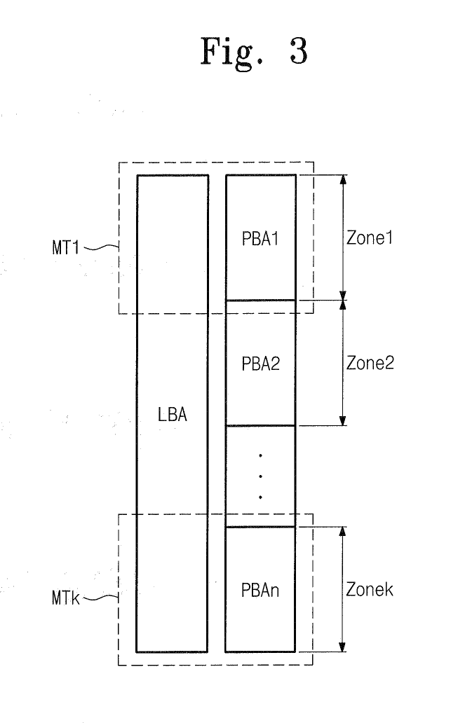

The controller 120 may distinguish a zone ID of a command based on a logical block address. The controller 120 may schedule commands such that commands having the same zone ID are successively executed. A zone may be a set of logical block addresses using one mapping table. This will be more fully described with reference to FIG. 3.

The controller 120 may exchange data with the host 101 via one of various interface protocols. For example, the controller 120 may exchange data with the host 101 via Universal Serial Bus (USB), MultiMediaCard (MMC), Peripheral Component Interconnect Express (PCI-E), Universal Flash Storage (UFS), Serial Advanced Technology Attachment (SATA), Parallel ATA (PATA), Small Computer System Interface (SCSI), Enhanced Small Disk Interface (ESDI), or Integrated Drive Electronics (IDE) interfaces. In exemplary embodiments of the inventive concept, the controller 120 may exchange data with the host 101 via the SATA interface protocol.

With the SATA interface, it is possible to overcome limits of a data transfer rate of a conventional ATA interface or a PATA interface. The SATA interface may support a native command queuing (NCQ) function in which a plurality of, for example, 32 commands are successively executed. Tagged command queuing (TCQ) may also be supported.

The NCQ may be used to improve the performance of a hard disk drive (HDD) supporting the SATA interface. With the NCQ technique, an order of commands may be changed and processed to minimize moving an arm of a disk in the HDD and rotating a platter thereof.

Unlike the HDD, however, the nonvolatile memory device 100 may not include mechanical composition. Therefore, the nonvolatile memory device 100 may provide an NCQ command scheduling method for controlling a command execution priority based on a logical block address of a command to process an NCQ command effectively.

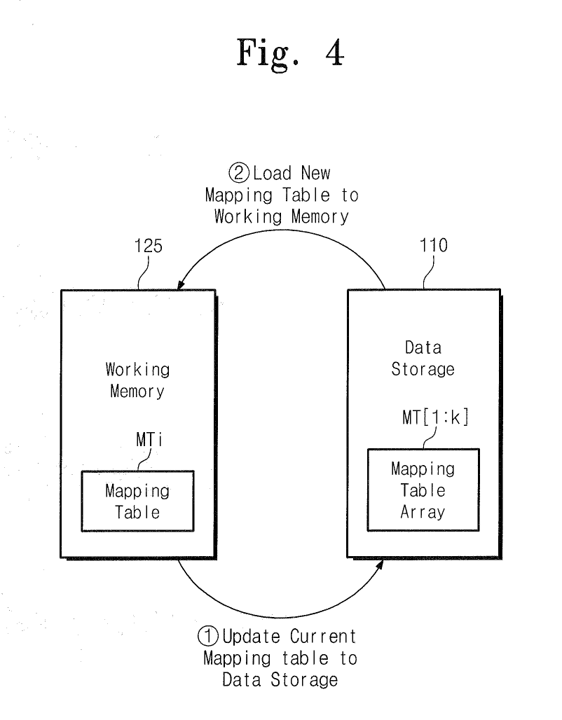

In the case that a working memory of the nonvolatile memory device 100 is small, a plurality of mapping tables may be used in a data processing operation. The nonvolatile memory device 100 may perform a table switching operation to execute commands necessitating different mapping tables. The nonvolatile memory device 100 may minimize a table switching operation using the command scheduling technique. This will be more fully described with reference to FIG. 4.

The inventive concept may not be limited to the SATA interface illustrated in FIG. 1. The inventive concept is applicable to a variety of interfaces. An interface applied to the nonvolatile memory device 100 according to an exemplary embodiment of the inventive concept is applicable to an interface technique for providing a command queuing function, for example, an interface technique such as SCSI.

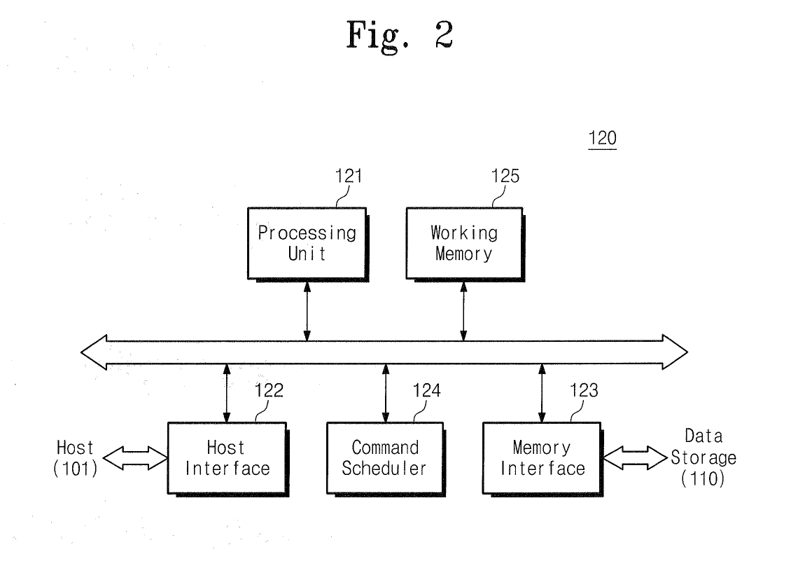

FIG. 2 is a block diagram illustrating a controller in FIG. 1. Referring to FIG. 2, a controller 120 may include a processing unit 121, a host interface 122, a memory interface 123, a command scheduler 124 and a working memory 125.

The processing unit 121 may include a central processing unit (CPU) or a micro-processing unit (MCU). The processing unit 121 may control an overall operation of the controller 120. The processing unit 121 may drive firmware for controlling the controller 120. The firmware may be loaded and driven on the working memory 125.

The host interface 122 may provide an interface between a host 101 and the controller 120. Data exchange between the host 101 and the controller 120 may be performed via one of various standardized interfaces. Alternatively, data exchange between the host 101 and the controller 120 may be performed via a plurality of various standardized interfaces. The standardized interfaces may include ATA, SATA, external SATA (e-SATA), SCSI, serial attached SCSI (SAS), PCI, PCI-E, UFS, USB, IEEE 1394, or Card interfaces.

The memory interface 123 may provide an interface between a data storage device 110 and the controller 120. For example, data processed by the processing unit 121 may be stored at the data storage device 110 via the memory interface 123. Alternatively, data stored at the data storage device 110 may be provided to the processing unit 121 via the memory interface 123.

The command scheduler 124 may queue commands input from the host 101. The command scheduler 124 may schedule the queued commands to control an execution priority of the commands. A mapping table switching time may be minimized by a command scheduling operation of the command scheduler 124.

In FIG. 2, there is illustrated an example in which the command scheduler 124 is independent. However, the command scheduler 124 can be formed of firmware which is loaded and driven on the working memory 125. The command scheduler 124 may be driven by the processing unit 121.

The working memory 125 may store firmware for controlling the controller 120 and data. The firmware and data stored at the working memory 125 may be driven by the processing unit 121. The working memory 125 may store metadata or cache data. At a sudden power-off operation, metadata or cache data stored at the working memory 125 may be stored at the data storage device 110. The working memory 125 may be formed of a cache memory, a dynamic RAM (DRAM), a static RAM (SRAM), a PRAM, or a combination thereof.

The working memory 125 may include a mapping table. The mapping table of the working memory 125 may be loaded from the data storage device 110 under the control of the processing unit 121.

In the case that the host 101 tries to access a nonvolatile memory device 100, it may provide a command including a logical block address to the nonvolatile memory device 100. The logical block address provided from the host 101 may refer to any location of logical memory space which software driven at the host 101 recognizes. Thus, the logical block address may not match up with a physical memory space of the data storage device 110. The processing unit 121 may convert the logical block address provided from the host 101 into a physical block address of the data storage device 110 to process data.

The mapping table may store mapping information between logical block addresses and physical block addresses. The mapping table may store logical block addresses and physical block addresses corresponding to the logical block addresses.

In the case that a size of the working memory 125 is small, whole mapping information between logical block addresses and physical block addresses may not be loaded on the working memory 125. The whole mapping information may be partitioned by a unit of a specific size to be loaded as mapping information on the working memory 125. Each of the partitioned portions of the mapping information may form one mapping table.

FIG. 3 is a diagram illustrating mapping tables according to an exemplary embodiment of the inventive concept. Referring to FIG. 3, mapping information may be divided into a plurality of mapping tables MT1 to MTk.

A whole logical block address (LBA) space may be divided into k zones each having a specific size. In each zone, logical block addresses and physical block addresses corresponding thereto may constitute a mapping table MTi (i being 1 to k).

Each zone may have a zone ID. For example, a zone having the smallest logical block address may have ID(1).

Mapping information on all logical block addresses may form a mapping table array. The mapping table array may be stored at a data storage device 110 (refer to FIG. 1). A part, including a logical block address of a command to be presently executed, from among the mapping table array may be loaded on a working memory 125 (refer to FIG. 2) from the data storage device 110. A part of the mapping table array may form a plurality of mapping tables.

At a data processing operation, there may be received a command including a logical block address from a host 101 (refer to FIG. 1). A command scheduler 124 (refer to FIG. 2) may distinguish a zone in which the logical block address of the input command is included.

If a mapping table of the distinguished zone does not exist at the working memory 125 including loaded mapping tables, a processing unit 121 (refer to FIG. 2) may load a mapping table of the distinguished zone on the working memory 125 from the data storage device 110. The processing unit 121 may convert the logical block address of the input command into a physical block address according to a newly loaded mapping table.

Thus, in the case that commands having logical block addresses included in different zones are successively executed, new mapping tables may continue to be loaded on the working memory 125 successively. This operation may be referred to as a table switching operation. The table switching operation will be more fully described with reference to FIG. 4.

FIG. 4 is a diagram illustrating a table switching operation according to an exemplary embodiment of the inventive concept. Referring to FIG. 4, a mapping table may be loaded on a working memory 125 from a data storage device 110. However, the inventive concept is not limited thereto. For example, a mapping table may be loaded on the working memory 125 from a nonvolatile memory included in a controller 120 (refer to FIG. 1) instead of the data storage device 110.

First, a command including a logical block address may be provided from a host 101 (refer to FIG. 1). A command scheduler 124 (refer to FIG. 2) may determine a zone in which the logical block address of the input command is included.

If a mapping table, corresponding to the determined zone, from among mapping tables loaded on the working memory 125 exists, a processing unit 121 (refer to FIG. 2) may execute the input command without a table switching operation.

If a mapping table, corresponding to the determined zone, from among the mapping tables loaded on the working memory 125 does not exist, the processing unit 121 may determine states of the mapping tables currently loaded on the working memory 125. For example, the processing unit 121 may determine whether states of the mapping tables (hereinafter, referred to as initial loading states) when the mapping tables are initially loaded on the working memory 125 are changed.

In the case that the initial loading states of the mapping tables are changed, the controller 120 may update a mapping table array MT[1:k] stored at the data storage device 110 with the changed mapping tables (\textcircled{1}). If the initial loading states of the mapping tables are not changed, the controller 120 may not perform an update operation. The above-described state determining and updating operations may be performed with respect to a mapping table of the mapping tables currently loaded on the working memory 125. A mapping table, not used for a long time, from among the mapping tables currently loaded on the working memory 125 may be decided to be the mapping table on which the state determining and updating operations are to be performed.

If the update operation is completed, the controller 120 may load a new mapping table of the determined zone on the working memory 125 (\textcircled{2}).

With the above-described table switching operation, the controller 120 may perform a table write operation and a load operation whenever commands having different zones are successively performed.

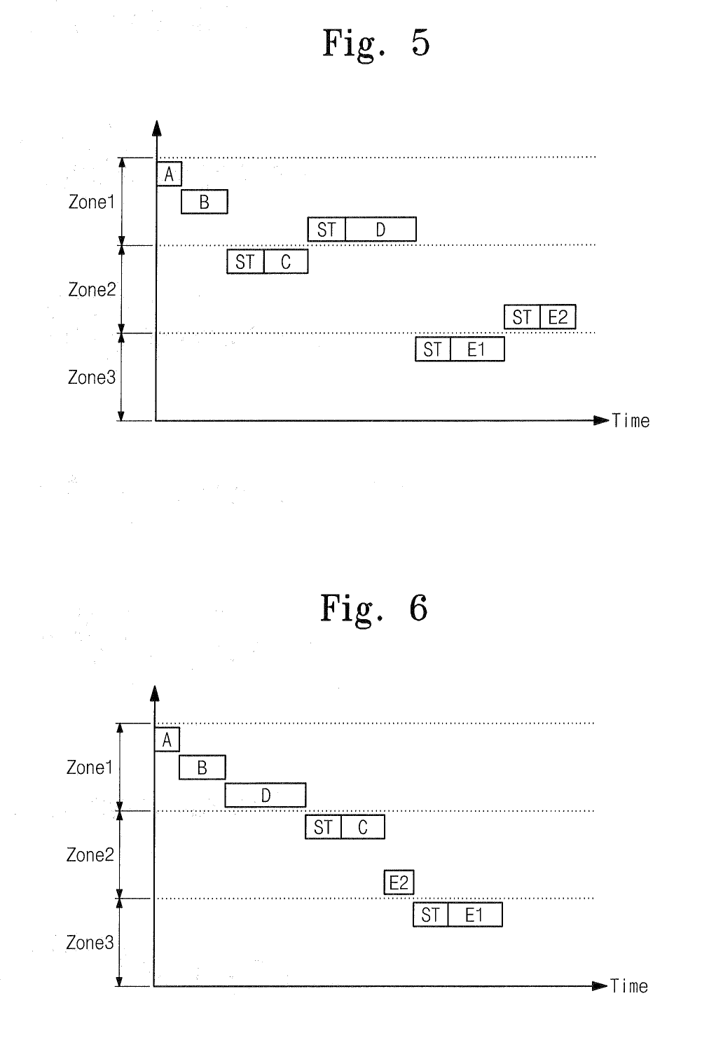

FIG. 5 is a timing diagram illustrating a general command execution operation. Referring to FIG. 5, a command may be performed according to an order in which it is provided from a host. A whole logical block address space may be divided into three zones. In FIG. 5, symbols “A”, “B”, “C”, “D”, “E1”, and “E2” may indicate command input from the host. A symbol “ST” may indicate a table switching time.

However, logical block addresses of the command B and C may exist at different zones. Thus, after the command B is performed, a table switching operation may be performed before the command C is performed.

A logical block address of a command input from the host does not have to exist in a single zone. For example, a part of a logical block address of a command E may exist at a zone 3, the remaining part may exist at a zone 2. In this case, a portion El, existing at the zone 3, from among the command E may be first performed. After a table switching operation is performed, a portion E2 existing at the zone 2 may be performed. Thus, although one command is executed, a table switching operation may be required.

FIG. 6 is a timing diagram illustrating a command execution operation according to an exemplary embodiment of the inventive concept. Referring to FIG. 6, commands may be reordered such that commands included in the same zone are successively performed. A whole logical block address space may be divided into three zones. In FIG. 6, symbols “A”, “B”, “C”, “D”, “E1”, and “E2” may indicate command input from the host. A symbol “ST” may indicate a table switching time.

Unlike a command execution operation of FIG. 5, commands A, B, and D included in a zone 1 may be first performed. After a table switching operation is performed, commands C and E2 included in a zone 2 may be executed. After a table switching operation is performed, a command E1 included in a zone 3 may be executed.

With the above-described command execution operation, a table switching operation may not be unnecessarily performed because commands included in the same zone are successively performed. Thus, a command execution time of a nonvolatile memory device 100 (refer to FIG. 1) may be reduced. For this, a controller 120 (refer to FIG. 1) may store commands input from a host 101 (refer to FIG. 1) to schedule the stored commands.

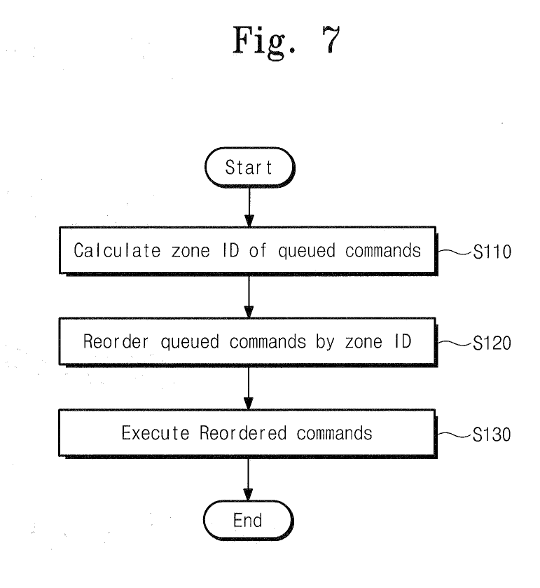

FIG. 7 is a flow chart illustrating a command scheduling method according to an exemplary embodiment of the inventive concept. Commands may be received from a host 101 (refer to FIG. 1). The input commands may be queued at a controller 120 (refer to FIG. 1) before execution of the input commands.

In operation S110, a zone corresponding to the queued commands may be determined. A zone corresponding to a command may be determined by calculating a zone ID based on a logical block address of the command. The zone ID may be calculated via a mod operation or a division operation on the logical block address of the command and a zone size.

In operation S120, the commands may be reordered based on the calculated zone ID. The commands may be reordered such that commands having the same zone ID are successively performed.

In operation S130, the reordered commands may be executed in order. With the above-described command scheduling operation, since commands included in the same zone are successively executed, an unnecessary table switching operation may not be performed. As a table switching operation is minimized, a command execution time may be reduced.

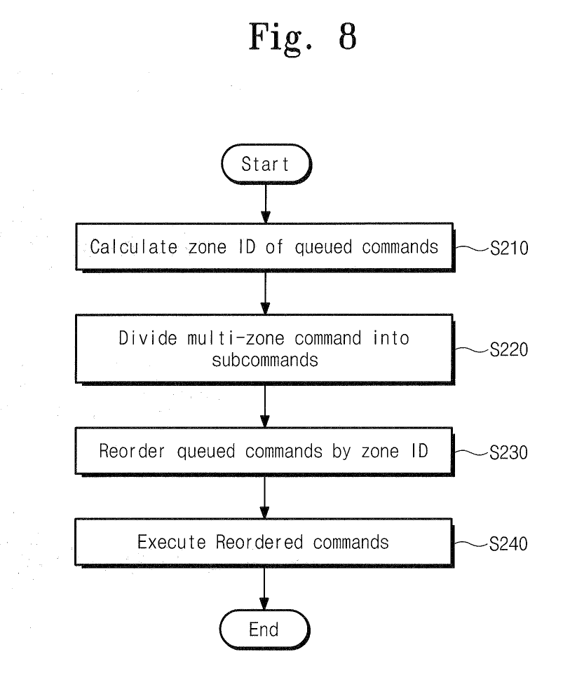

FIG. 8 is a flow chart illustrating a command scheduling method according to an exemplary embodiment of the inventive concept. A command scheduling method in FIG. 8 may divide commands corresponding to a plurality of zones into subcommands corresponding to one zone and reorder the divided subcommands independently.

Commands may be received from a host 101 (refer to FIG. 1). The input commands may be queued at a controller 120 (refer to FIG. 1) without instant execution of the input commands.

In operation S210, a zone corresponding to the queued commands may be determined. A zone corresponding to a command may be determined by calculating a zone ID based on a logical block address of the command. The zone ID may be calculated via a mod operation or a division operation on the logical block address of the command and a zone size.

In operation S220, a command corresponding to a plurality of zones may be divided into subcommands corresponding to a zone. For example, a command including a logical block address included in a zone 1 and a logical block address included in a zone 2 may be divided into a subcommand having a logical block address included in the zone 1 and a subcommand having a logical block address included in the zone 2. The divided subcommands may have different zone IDs.

In operation S230, commands may be reordered based on the calculated zone ID. The divided subcommands may be reordered independently. Commands may be reordered such that commands having the same zone ID are successively executed.

In operation S240, the reordered commands may be executed in order. With the above-described command scheduling operation, since commands included in the same zone are successively executed, an unnecessary table switching operation may not be performed. In addition, since the same command is reordered independently to correspond to a zone ID, a table switching operation may be further reduced. As the table switching operation is minimized, a command execution time may be reduced.

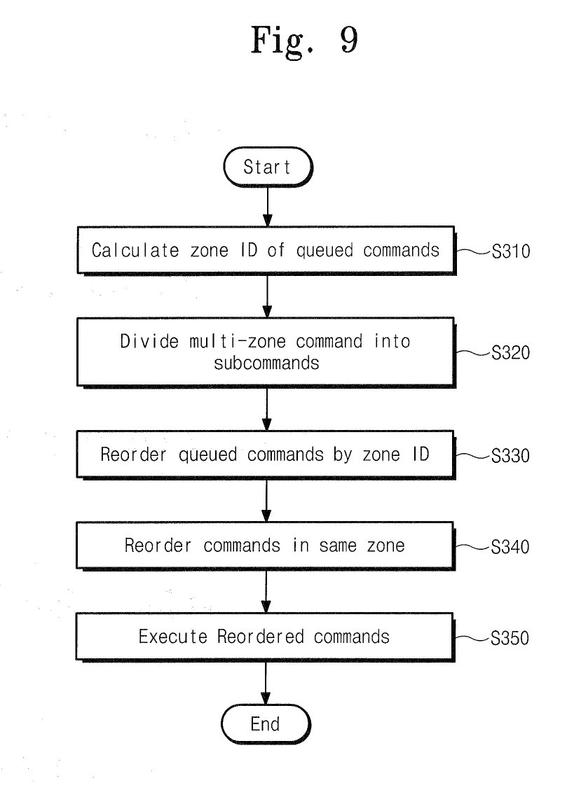

FIG. 9 is a flow chart illustrating a command scheduling method according to an exemplary embodiment of the inventive concept. A command scheduling method of FIG. 9 may reorder commands to correspond to a zone ID and internally reorder commands in the same zone.

Commands may be received from a host 101 (refer to FIG. 1). The input commands may be queued at a controller 120 without instant execution of the input commands.

In operation S310, a zone corresponding to the queued commands may be determined. A zone corresponding to a command may be determined by calculating a zone ID based on a logical block address of the command. The zone ID may be calculated via a mod operation or a division operation on the logical block address of the command and a zone size.

In operation S320, a command corresponding to a plurality of zones may be divided into subcommands corresponding to a zone. For example, a command including a logical block address included in a zone 1 and a logical block address included in a zone 2 may be divided into a subcommand having a logical block address included in the zone 1 and a subcommand having a logical block address included in the zone 2. The divided subcommands may have different zone IDs.

In operation S330, commands may be reordered based on the calculated zone ID. The divided subcommands may be reordered independently. Commands may be reordered such that commands having the same zone ID are successively executed.

In operation S340, commands having the same zone ID may be internally reordered. Commands may be reordered such that commands having adjacent logical block addresses are successively executed. Alternatively, commands may be reordered such that a read command is executed prior to execution of a write command.

In operation S350, the commands reordered at operations S330 and S340 may be executed in order. With the above-described command scheduling operation, since commands included in the same zone are successively executed, an unnecessary table switching operation may not be performed. In addition, since the same command is reordered more efficiently, a command execution time may be reduced.

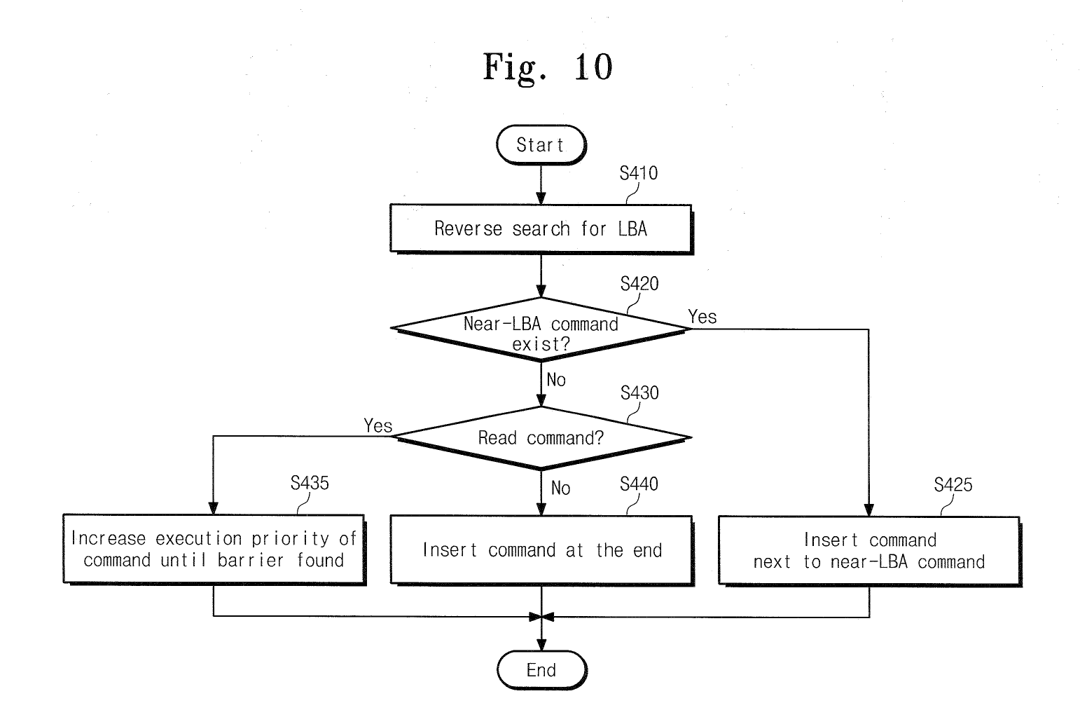

FIG. 10 is a flow chart illustrating an operation of reordering commands having the same zone ID, according to an exemplary embodiment of the inventive concept. First, whether a new command belongs to a specific zone may be determined. The new command may be inserted between a series of commands which are determined to exist at the same zone and are previously reordered.

In operation S410, a reverse search may be performed with respect to logical block addresses of previously reordered commands. The reverse search may indicate an operation in which logical block addresses are determined sequentially from a command having the lowest priority.

In operation S420, whether a command having a logical block address near to that of the new command exists during the reverse search may be determined.

If a command having a logical block address near to that of the new command exists, in operation S425, the new command may be inserted at a next order of the adjacent logical block address command.

If a command having a logical block address near to that of the new command does not exist, in operation S430, whether the new command is a read command may be determined. Since a user wants a read command to be executed instantly prior to a write command, the read command may have an execution priority prior to the write command.

In operation S435, if the new command is a read command, an execution priority of the new command may increase until a barrier is found. Herein, the barrier may indicate a state at which an abnormal operation is generated when an execution priority further increases due to a write command on the same logical block address.

In operation S440, if the new command is not a read command, it may be inserted at the end of previously reordered commands. If the new command is inserted, the method may be ended.

There is described above an exemplary embodiment of the inventive concept in which a reordering operation based on an adjacent logical block address and a reordering operation based on a read command are sequentially performed at a reordering operation on commands having the same zone ID. However, the inventive concept is not limited thereto.

With the above-described command reordering operation, since commands included in the same zone are reordered more efficiently, a command execution time may be reduced.

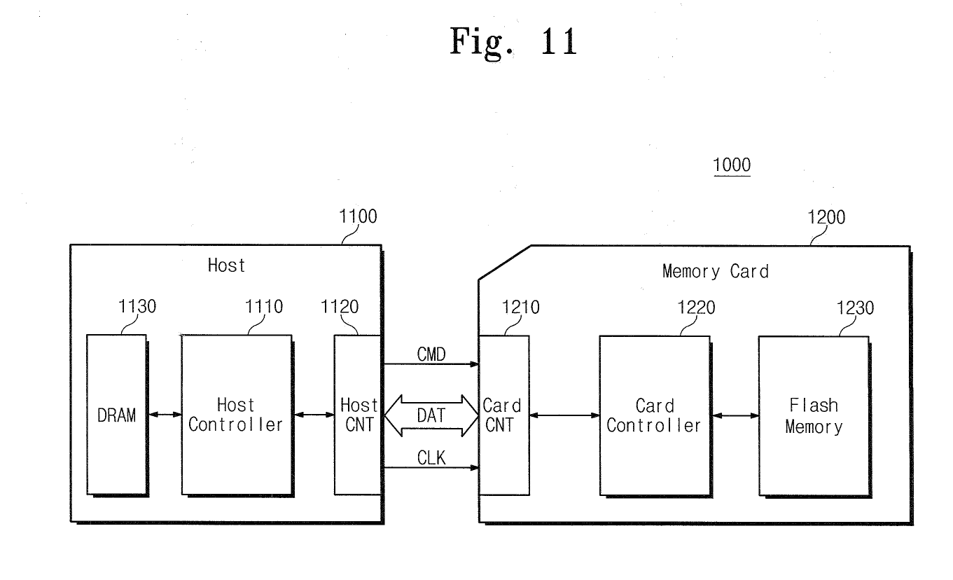

FIG. 11 is a block diagram illustrating a memory card system including a nonvolatile memory device according to an exemplary embodiment of the inventive concept. A memory card system 1000 may include a host 1100 and a memory card 1200. The host 1100 may include a host controller 1110, a host connection unit 1120, and a DRAM 1130.

The host 1100 may write data to the memory card 1200 and read data from the memory card 1200. The host controller 1110 may send a command CMD (e.g., a write command), a clock signal CLK generated from a clock generator (not shown) in the host 1100, and data DAT to the memory card 1200 via the host connection unit 1120. The DRAM 1130 may be a main memory of the host 1100.

The memory card 1200 may include a card connection unit 1210, a card controller 1220, and a flash memory 1230. The card controller 1220 may store data at the flash memory 1230 in response to a command input via the card connection unit 1210. The data may be stored in synchronization with the clock signal CLK generated from the clock generator (not shown) in the card controller 1220. The flash memory 1230 may store data transferred from the host 1100. For example, in a case where the host 1100 is a digital camera, the memory card 1200 may store image data.

The memory card system 1000 in FIG. 11 may reorder and execute commands input from the host 1100 at a data processing operation on the flash memory 1230. As described above, commands may be reordered to correspond to logical block addresses. With a command scheduling operation, a command execution speed of the memory card system 1000 may be improved.

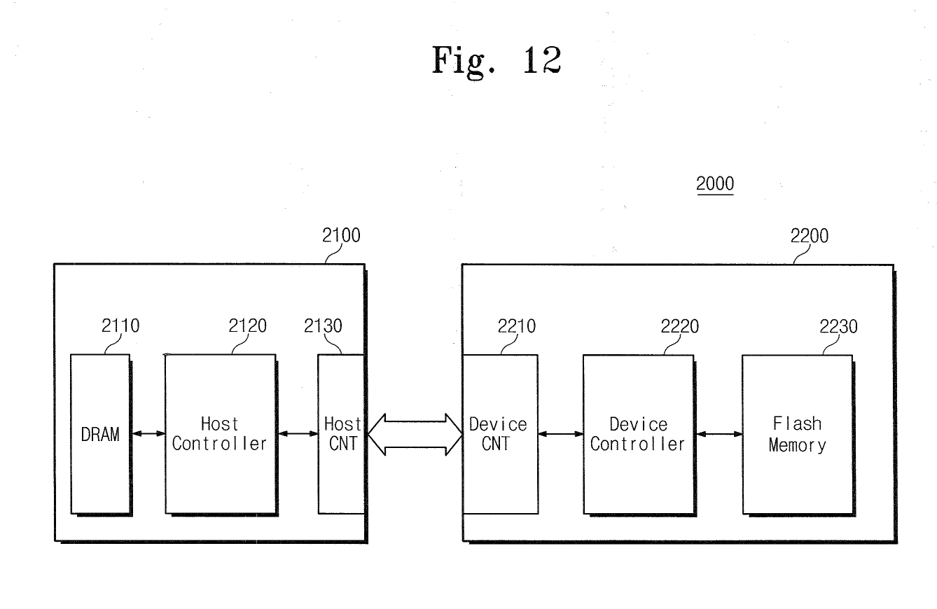

FIG. 12 is a block diagram illustrating a UFS in which a nonvolatile memory device according to an exemplary embodiment of the inventive concept is applied. Referring to FIG. 12, a UFS system 2000 may include a UFS host 2100 and a UFS device 2200. The UFS host 2100 may include a host controller 2120, a host connection unit 2130, and a DRAM 2110.

The UFS host 2100 may write data in the UFS device 2200 or read data from the UFS device 2200. The DRAM 2110 may be a main memory of the UFS host 2100. The UFS host 2100 may communicate with the UFS device 2200 via the host connection unit 2130 and a device connection unit 2210 of the UFS device 2200. The host and device connection units 2130 and 2210 may include a MIPI M-PHY solution.

The UFS device 2200 may include the device connection unit 2210, a device controller 2220, and a flash memory 2230. The device controller 2220 may store data at the flash memory 2230 in response to a command input via the device connection unit 2210. The flash memory 2230 may store data transferred from the UFS host 2100.

The device controller 2220 of the UFS system 2000 in FIG. 12 may provide a command queuing operation. The device controller 2220 may reorder and execute commands input from the UFS host 2100 at a data processing operation on the flash memory 2230. As described above, commands may be reordered to correspond to logical block addresses. With a command scheduling operation, a command execution speed of the UFS system 2000 may be improved.

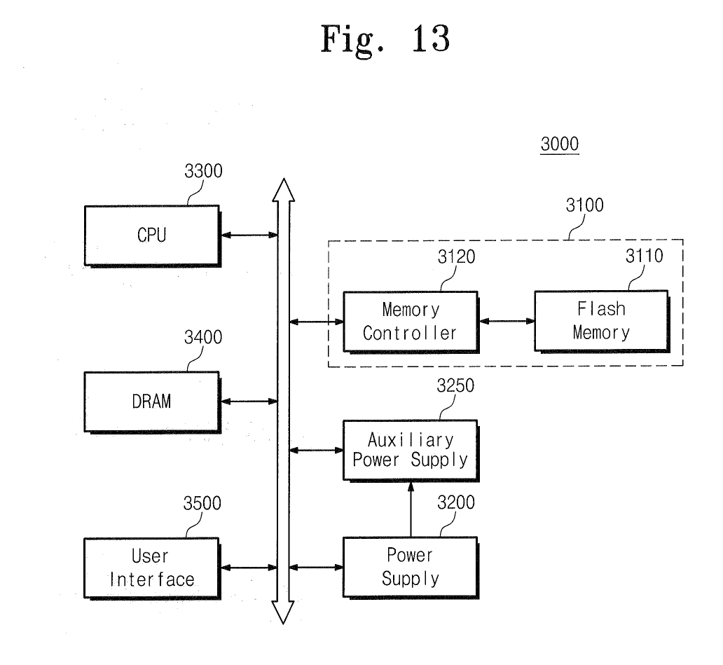

FIG. 13 is a block diagram illustrating an electronic device implemented using a memory device according to an exemplary embodiment of the inventive concept. Herein, an electronic device 3000 may be a personal computer or a handheld electronic device such as a notebook computer, a cellular phone, a PDA, a camera, or the like.

Referring to FIG. 13, the electronic device 3000 may include a memory device 3100, a power supply device 3200, an auxiliary power supply 3250, a CPU 3300, a DRAM 3400, and a user interface 3500. The memory device 3100 may include a flash memory 3110 and a memory controller 3120. The memory device 3100 can be built in the electronic device 3000.

The electronic device 3000 according to an exemplary embodiment of the inventive concept may reorder and execute commands input from a host at a data processing operation on the flash memory 3110. As described above, commands may be reordered to correspond to logical block addresses. With a command scheduling operation, a command execution speed of the electronic device 3000 may be improved.

While the inventive concept has been shown and described with reference to exemplary embodiments thereof, it will be apparent to those of ordinary skill in the art that various changes in form and detail may be made thereto without departing from the spirit and scope of the present inventive concept as defined by the following claims.

What is claimed is:

1. A controller, comprising:
a working memory on which a command scheduler is loaded; and
a processor configured to load at least one mapping table from a mapping table array onto the working memory,
wherein the command scheduler reorders commands provided from a host based on logical block addresses; and wherein the processor loads at least one other mapping table onto the working memory according to logical block addresses of the commands reordered by the command scheduler.

2. The controller of claim 1, wherein the command scheduler reorders the commands such that commands having logical block addresses included in the same mapping table are successively executed.

3. The controller of claim 2, wherein logical block addresses of the commands are determined to be included in the same mapping table based on the logical block addresses of the commands and a size of a logical block address included in at least one of the mapping tables.

4. The controller of claim 1, wherein the mapping table array is stored at a data storage device which stores data according to a control of the controller.

5. The controller of claim 1, further comprising:
a nonvolatile memory at which the mapping table array is stored.

6. The controller of claim 1, wherein the commands are Native Command Queuing (NCQ) or Tagged Command Queuing (TCQ) commands.

7. The controller of claim 6, wherein the controller provides an interface to queue commands.

8. A command scheduling method of a nonvolatile memory device, comprising:
determining logical block addresses of commands provided from a host;
determining zones in which the logical block addresses of the commands are included; and
reordering the commands based on the determined zones,
wherein each of the zones includes at least one logical block address included in a mapping table.

9. The command scheduling method of claim 8, wherein the zones are determined on the basis of a size of a logical block address included in at least one of the mapping tables and the logical block addresses of the commands.

10. The command scheduling method of claim 8, further comprising:
dividing commands having a logical block address included in a plurality of zones into subcommands,
wherein reordering the commands comprises reordering the subcommands based on their zones.

11. The command scheduling method of claim 8, wherein reordering the commands comprises:
identifying the commands having logical block addresses belonging to the same zone; and
reordering the commands in the same zone.

12. The command scheduling method of claim 11, wherein the commands in the same zone are reordered such that commands having adjacent logical block addresses are successively executed.

13. The command scheduling method of claim 12, wherein reordering the commands in the same zone comprises:
determining a logical block address next to a command having a lowest execution priority; and
reordering the commands in the same zone, based on the logical block address next to the command having the lowest execution priority, such that commands having adjacent logical block addresses are successively executed.

14. The command scheduling method of claim 11, wherein the commands in the same zone are reordered such that a read command is executed prior to a write command.

15. The command scheduling method of claim 11, wherein the commands in the same zone are reordered according to an order in which they were received.

16. A controller, comprising:
a command scheduler configured to calculate zone identities (IDs) for a plurality of queued commands and re-queue the commands based on the zone IDs,
wherein a zone includes a logical block address and a physical block address.

17. The controller of claim 16, wherein the commands are re-queued such that commands having the same zone ID are successively executed.

18. The controller of claim 16, wherein the controller includes an interface to receive the commands.

19. The controller of claim 16, further comprising a working memory on which the command scheduler is stored.

20. The controller of claim 16, further comprising a data storage device configured to provide the working memory with a mapping table.
